(19) United States
(12) Patent Application Publication
(10) Pub. No.: US 2018/0097727 A1
(43) Pub. Date: Apr. 5, 2018

(54) NETWORK SYSTEM, NODE APPARATUS, CONTROL APPARATUS, COMMUNICATION CONTROL METHOD, AND CONTROL METHOD

(71) Applicant: NEC Corporation, Tokyo (JP)

(72) Inventors: Ippei AKIYOSHI, Tokyo (JP); Jun NISHIOKA, Tokyo (JP); Noriaki KISHITA, Tokyo (JP)

(73) Assignee: NEC Corporation, Tokyo (JP)

(21) Appl. No.: 15/562,479

(22) PCT Filed: Mar. 24, 2016
(86) PCT No.: PCT/JP2016/001708

§ 371 Date: Sep. 28, 2017

(30) Foreign Application Priority Data
Mar. 30, 2015 (JP) 2015-068490

(51) Int. Cl. H04L 12/715; H04L 12/721; H04L 12/717

(52) U.S. Cl. CPC H04L 45/64; H04L 45/74; H04L 45/42; H04L 45/38

(57) ABSTRACT

A network system, a node apparatus, a control apparatus, a communication control method, and a control method are provided that make it possible to easily perform control of a physical layer device required for flow control. In a communication system including a plurality of nodes constituting a network and a control apparatus controlling each node in units of flows, at least one communication interface is provided to each port of the nodes; the control apparatus instructs the node to set a physical layer mode on a port, and the node, in accordance with the physical layer mode indicated by the control apparatus, make setting of a corresponding communication interface.

### TECHNICAL FIELD

The present invention relates to a network system based on Software Defined Networking (SDN) technology, and more particularly to a node control technique in an SDN network system.

### BACKGROUND ART

In recent years, a new network technology called Software Defined Networking (hereinafter, abbreviated as SDN) has been proposed, and its constituent technology—network platform such as OpenFlow™ (hereinafter, the same applies)—has been developed as open source (NPL1 and others). The basic idea of OpenFlow technology is that the data plane and the control plane are separated, enabling them to be developed independently. This separated architecture allows a switch to become a configurable open platform from a closed system.

As illustrated in FIG. 1, consider an SDN network composed of a network including a plurality of forwarding nodes and a control apparatus that controls the forwarding nodes. For example, in OpenFlow, a series of communications determined by combining identifiers, such as a packet's input physical port number (L1 layer), MAC (Media Access Control) address (L2 layer), IP address (L3 layer), and port number (L4 layer), is defined as a “flow”, and routing is implemented per flow. An OpenFlow switch (OFS) functioning as a forwarding node operates in accordance with a flow table, which is rewritten based on an instruction from an OpenFlow controller (OFC) functioning as a control apparatus.

In the flow table, a flow entry, which is composed of rule, statistical information, and action that defines processing to be applied to a packet matching the rule, is stored for each flow. The rule is a condition for identifying a flow, and the statistical information is network-related statistical information such as the total number of packets or the total size of packets in the flow. The OpenFlow controller (OFC) can understand the status of an entire network by collecting statistical information from each OFS. As an example of the action, in case of “output”, which instructs to forward a packet from a designated physical port, it is possible to designate, as the output physical port(s), all physical ports other than the input physical port (ALL), a physical port that forwards to the controller (CONTROLLER), the input physical port (IN_PORT), or the like.

### CITATION LIST

### Non Patent Literature

[NPL 1]

### N. McKeown et al. “OpenFlow: Enabling Innovation in Campus Networks” ACM SIGCOMM Computer Communication Review, 38(2):69-74, April 2008

### SUMMARY

### Technical Problem

However, the above-described SDN is mainly to control the layer 2 (L2) and above. Although there is a demand that control of the physical layer (L1) and under such as optical and radio wave media should be made open, the technologies for the physical layer are not sufficiently mature, and the present situation is that mutual connections between different vendors are not achieved. For this reason, even if control of L1 and under becomes open, an SDN controller needs to perform control taking vendor-specific characteristics into consideration, which may cause problems such as an increase in control load and a decrease in processing rate.

Accordingly, an object of the present invention is to provide a network system, a node apparatus, a control apparatus, a communication control method, and a control method that make it possible to easily control a physical layer device required for flow control.

### Solution to Problem

A communication system according to the present invention is a communication system including a plurality of nodes constituting a network and a control apparatus controlling each node in units of flows, wherein the communication system is characterized in that at least one communication interface is provided to each port of the node, the control apparatus instructs the node to set a physical layer mode on the port, and the node, in accordance with the physical layer mode indicated by the control apparatus, makes setting of a corresponding communication interface.

A node apparatus according to the present invention is a node apparatus in a network controlled by a control apparatus, wherein the node apparatus is characterized by including: forwarding means that forwards packets in accordance with control in units of flows by the control apparatus, wherein the forwarding means has a plurality of ports to transmit or receive packets to or from the network; at least one communication interface provided to each of the plurality of ports; and mode management means that, in accordance with a physical layer mode of a port designated by the control apparatus, makes setting of a communication interface provided to the designated port.

A control apparatus according to the present invention is a control apparatus that performs control in units of flows for each of a plurality of nodes constituting a network, wherein the control apparatus is characterized by including: a mode table in which one or more physical layer modes are defined for each port of the node; and node management means which notifies a node of mode designation information for designating a physical layer mode of one port of the node.

A communication control method in a communication system according to the present invention is a communication control method in a communication system including a plurality of nodes constituting a network and a control apparatus controlling each node in units of flows, wherein the communication control method is characterized by: providing at least one communication interface to each port of the node; by the control apparatus, instructing the node to set a physical layer mode on a port; and by the node, in accordance with the physical layer mode indicated by the control apparatus, making setting of a corresponding communication interface.

A communication control method for a node apparatus according to the present invention is a communication control method for a node apparatus, wherein the node apparatus includes: a plurality of ports to transmit or receive packets to or from a network controlled by a control apparatus; forwarding means that forwards packets in accordance with control in units of flows by the control apparatus; and at least one communication interface provided to each of the plurality of ports, the method characterized by: receiving mode designation information for designating a physical layer mode of a port from the control apparatus; and making setting of a communication interface provided to the designated port, in accordance with the mode designation information.

A control method according to the present invention is a control method for controlling in units of flows each of a plurality of nodes constituting a network, characterized by: by a mode table, storing one or more physical layer modes of each port of the node; and by node management means, notifying a node of mode designation information for designating a physical layer mode of one port of the node.

### Advantageous Effects of Invention

According to the present invention, a control apparatus defines a physical layer mode for each port and the node sets its own physical layer device according to the physical layer mode of a port designated by the control apparatus, whereby it is possible to easily control the physical layer device required for flow control.

### BRIEF DESCRIPTION OF DRAWINGS

FIG. 1 is a schematic diagram showing a network system architecture for describing a background art.

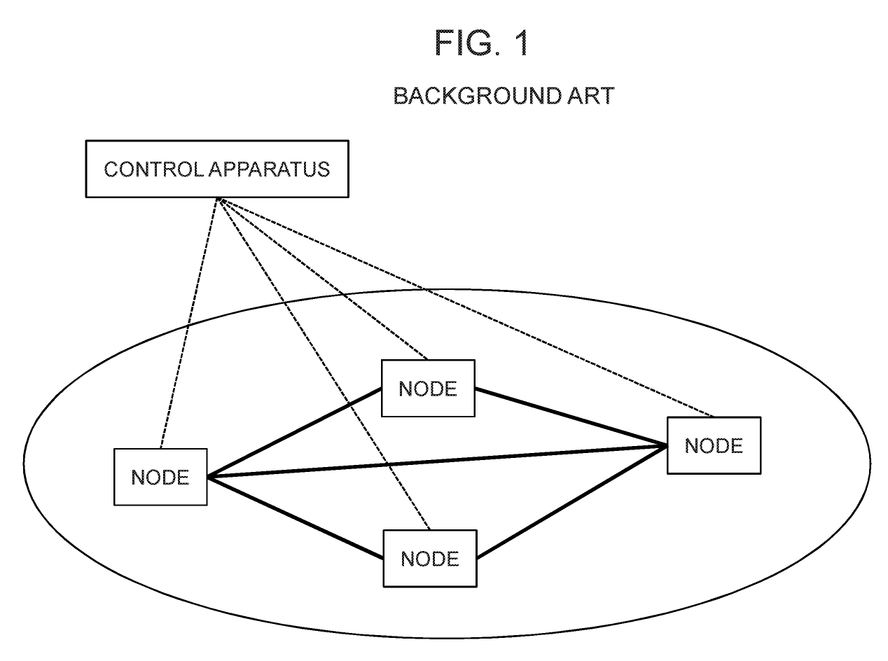

FIG. 2 is a block diagram showing the schematic configurations of a control apparatus and each node in a network system according to a first exemplary embodiment of the present invention.

FIG. 3 is a schematic diagram showing an example of the data structure of a mode database in the control apparatus 10 shown in FIG. 2.

FIG. 4 is a schematic diagram showing an example of the data structure of a mode management database in the node shown in FIG. 2.

FIG. 5 is a sequence chart showing operation in the network system according to the first exemplary embodiment.

FIG. 6 is a diagram showing the schematic architecture of a network system according to a second exemplary embodiment of the present invention.

FIG. 7 is a block diagram showing an example of the configuration of a packet forwarding control apparatus according to the second exemplary embodiment.

FIG. 8 is a block diagram showing an example of the configuration of a packet forwarding function section according to the second exemplary embodiment.

FIG. 9 is a block diagram showing an example of the partial configuration of one communication interface associated with one port of the packet forwarding function section according to the second exemplary embodiment.

FIG. 10 is a schematic diagram showing an example of the data structure of a mode database in the packet forwarding control apparatus, in the example of configuration shown in FIG. 9.

FIG. 11 is a schematic diagram showing an example of the data structure of a mode management database in the packet forwarding function section, in the example of configuration shown in FIG. 9.

FIG. 12 is a block diagram showing an example of the partial configuration of a plurality of communication interfaces associated with one port of the packet forwarding function section according to the second exemplary embodiment.

FIG. 13 is a schematic diagram showing an example of the data structure of a mode database in the packet forwarding control apparatus, in the example of configuration shown in FIG. 12.

FIG. 14 is a schematic diagram showing an example of the data structure of a mode management database in the packet forwarding function section, in the example of configuration shown in FIG. 12.

FIG. 15 is a diagram showing the schematic architecture of a network system according to a third exemplary embodiment of the present invention.

FIG. 16 is a block diagram showing an example of the configuration of a packet forwarding control apparatus according to the third exemplary embodiment.

FIG. 17 is a schematic diagram showing an example of the data structure of a link information table included in a topology management section of the packet forwarding control apparatus shown in FIG. 16.

FIG. 18 is a diagram showing the schematic architecture of a network system according to a fourth exemplary embodiment of the present invention.

FIG. 19 is a block diagram showing an example of the configuration of a plurality of communication interfaces associated with one port of a packet forwarding function section according to the fourth exemplary embodiment.

FIG. 20 is a schematic diagram showing an example of the data structure of a mode database in a packet forwarding control apparatus shown in FIG. 18.

FIG. 21 is a schematic diagram showing an example of the data structure of a mode management database in a packet forwarding function section shown in FIG. 18.

FIG. 22 is a diagram showing the schematic architecture of a network system according to a fifth exemplary embodiment of the present invention.

FIG. 23 is a schematic diagram showing an example of the data structure of a mode database in a packet forwarding control apparatus shown in FIG. 22.

FIG. 24 is a schematic diagram showing an example of the data structure of a mode management database in a packet forwarding function section shown in FIG. 22.

### DETAILED DESCRIPTION

### <Outline of Exemplary Embodiments>

According to exemplary embodiments of the present invention, a control apparatus that controls nodes in a network defines one or more physical layer configuration mode (hereinafter, referred to as “physical layer mode”) for each port of each node, and in accordance with the physical layer mode designated by the control apparatus, a node makes a setting change to a physical device associated with the relevant port, for example, changing a physical parameter of one physical device, switching to another physical device, or the like. Accordingly, the control apparatus does not need to take into consideration the vendor-specific characteristics of a physical layer device provided to each node, allowing the reduced load of controlling physical layer devices required for flow control. A physical layer mode is composed of at least one or more logical parameter (e.g., link capacity, delay, power consumption, and the like), and the control apparatus can select a physical layer mode for each port, depending on the network status. Hereinafter, exemplary embodiments and examples of the present invention will be described in detail with reference to drawings.

### 1. First Exemplary Embodiment

### 1.1) System Architecture

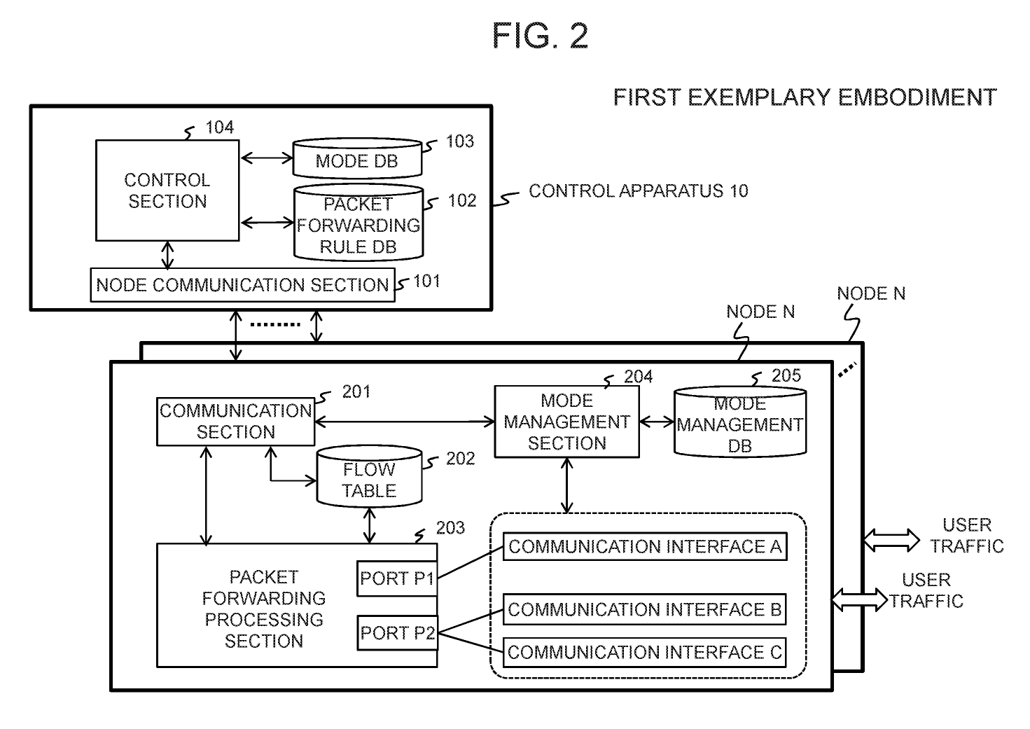

Referring to FIG. 2, a network system according to a first exemplary embodiment of the present invention includes a plurality of nodes N connected through wired or wireless physical links and a control apparatus 10 that controls each node. The control apparatus 10 defines one or a plurality of physical layer mode for each port of each node, and each node makes a setting change to a physical device corresponding to a physical layer mode designated by the control apparatus 10.

The control apparatus 10 includes a node communication section 101 for communicating with each node N, a packet forwarding rule database (DB) 102, a mode DB 103, and a control section 104. Routing in units of flows using the packet forwarding rule DB 102 is similar to that of the background art, and therefore a detailed description thereof will be omitted. The mode DB 103 is a table in which one or more physical layer mode is defined for each port of each node. A detailed description thereof will be given later.

Each node N includes a communication section 201 for communicating with the control apparatus 10, a flow table 202, a packet forwarding processing section 203, a mode management section 204, and a mode management DB 205. Routing in units of flows using the flow table 202 and packet forwarding processing section 203 is similar to that of the background art, and therefore a detailed description thereof will be omitted. According to the present exemplary embodiment, one or a plurality of communication interfaces are associated with each port of the packet forwarding processing section 203. Here, for simplification, it is assumed that one communication interface A is associated with a port P1, and two interfaces B and C are associated with another port P2. The mode management DB 205 is a table in which one or more physical layer mode is defined for each port, and setting parameters on a communication interface corresponding to each of the modes are stored. A detailed description thereof will be given later.

For a communication medium of a communication interface, whichever medium, electricity, light, or radio waves, may be used. However, at least one communication interface at each port needs to be able to change its communication parameter such as communication bandwidth, communication rate, or transmission power. Here, the mode management section 204 can change the parameter setting of a communication interface associated with each port in accordance with an instruction from the control apparatus 10.

### <Mode DB>

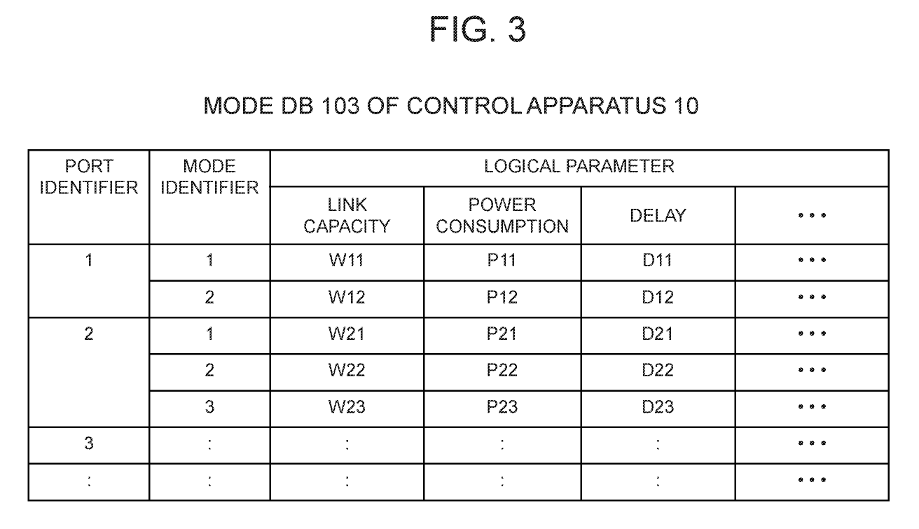

Referring to FIG. 3, the mode DB 103 of the communication apparatus 10 stores mode information for each port of each node. For a node shown in FIG. 3, two modes (mode ID=1, 2) are defined for port identifier (ID)=1, and three modes (mode ID=1, 2, 3) are defined for port ID=2. Each mode is defined by logical parameters such as link capacity, power consumption, and delay. For example, a combination of port ID=1 and mode ID=1 corresponds to a physical layer mode defined by a link capacity of W11, a power consumption of P11, a delay of D11, and the like. Accordingly, information specifying a physical layer mode can be used to indicate to any node a condition to be satisfied by an interface at the relevant port. Hereinafter, a combination of a port ID and a mode ID will be used as an example of the information specifying a physical layer mode, but it is also possible to use a maximum link capacity in place of a mode ID.

### <Mode Management DB>

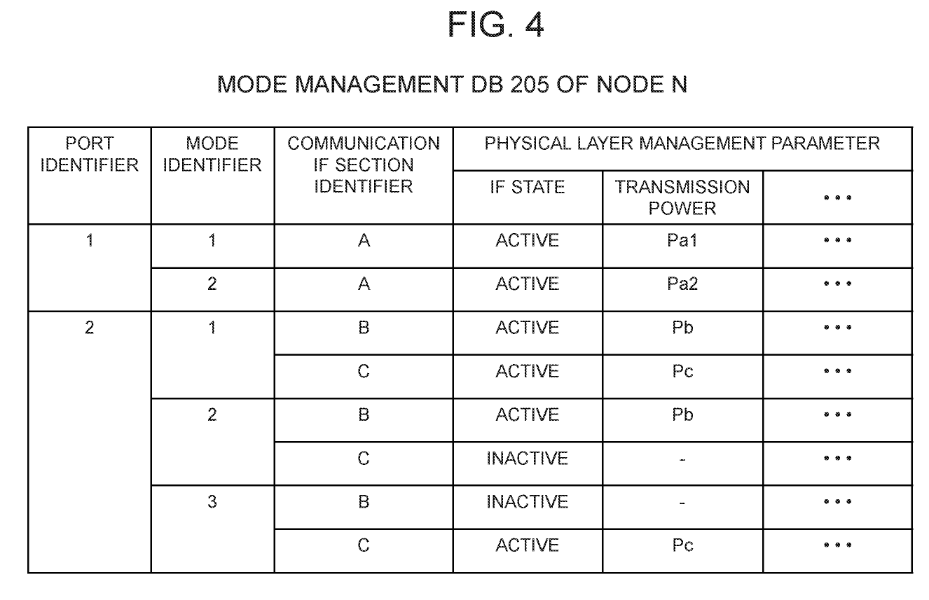

Referring to FIG. 4, the mode management DB 205 of each node N stores communication interface setting information for each mode defined for each port. Combinations of a port and a mode in the mode management DB 205 correspond to the combinations of a port and a mode defined in the mode DB 103 of the control apparatus 10. In other words, the physical setting of a communication interface at a node N is defined such as to satisfy a physical layer condition specified by a combination of a port and a mode defined in the control apparatus 10.

Port ID=1 shown in FIG. 4 corresponds to the port P1 shown in FIG. 2, and two modes (mode ID=1, 2) are defined for this port. The modes correspond to two setting states of a single communication interface A, respectively. Here, it is assumed that the communication interface A can change transmission power, and the transmission power parameter of the communication interface A is set to Pa1 when mode ID=1, and is set to Pa2 when mode ID=2.

Port ID=2 shown in FIG. 4 corresponds to the port P2 shown in FIG. 2, and three modes (mode ID=1, 2, 3) are defined for this port. Each of the modes corresponds to a combination of respective setting states of two communication interfaces B and C. Here, it is assumed that the communication interfaces B and C are set to specific transmission powers, respectively. More specifically, when mode ID=1, the communication interfaces B and C are both active, whereby the transmission power of this port P2 is set to Pb+Pc. When mode ID=2, the communication interface B is active and the communication interface C is inactive, whereby the transmission power of the port P2 is set to Pb. When mode ID=3, the communication interface B is inactive and the communication interface C is active, whereby the transmission power of the port P2 is set to Pc.

As described above, although a physical layer mode defined in the mode management DB 205 corresponds to physical layer mode information designated by the control apparatus 10, the contents of the management parameters are based on the communication interface(s) (physical device(s)) connected to each port of each node N. Hereinafter, operation in the present exemplary embodiment will be described.

### 1.2) Operation

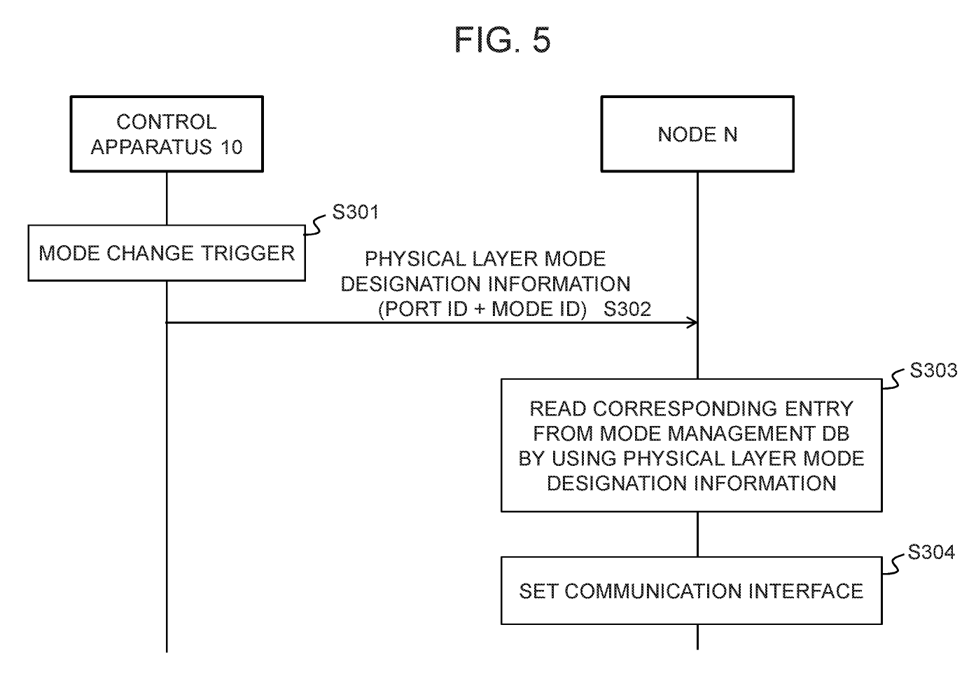

Referring to FIG. 5, when a mode change trigger occurs (Operation S301), the control section 104 of the control apparatus 10 refers to the mode DB 103 and starts control for changing the physical layer mode of a port of a node N. The mode change trigger is, for example, a case in which it is determined that a communication parameter should be changed, based on statistical information acquired from the node N and a predetermined control policy. In this case, the control section 104 selects, in accordance with the control policy, an appropriate one of the plurality of modes defined for the corresponding port in the mode DB 103, and notifies physical layer mode designation information including this port ID and the selected mode ID to this node N via the node communication section 101 (Operation S302). The physical layer mode designation information can be sent by using, for example, Port Modification Message of OpenFlow. Alternatively, it is also possible to designate a physical layer mode by performing edit-config operation of NETCONF by using RPC (Remote Procedure Control).

When receiving the physical layer mode designation information from the control apparatus 10 via the communication section 201, the mode management section 204 of the node N refers to the mode management DB 205 and reads an entry that matches the port ID and mode ID in this physical layer mode designation information (Operation S303). The mode management section 204 sets the communication interface in accordance with physical layer management parameters in the read entry (Operation S304).

For example, when the physical layer mode designation information indicating port ID=1 and mode ID=1 is received from the control apparatus 10, the mode management section 204 reads an entry corresponding to port ID=1 and mode ID=1 (communication interface A=active, a transmission power of Pal , and the like) from the mode management DB 205 and sets the communication interface A accordingly. When the physical layer mode designation information indicating port ID=1 and mode ID=2 is received from the control apparatus 10, the mode management section 204 reads a corresponding entry (communication interface A=active, a transmission power of Pa2, and the like) and sets the communication interface A accordingly. When the physical layer mode designation information indicating port ID=2 and mode ID=2 is received from the control apparatus 10, the mode management section 204 reads a corresponding entry (communication interface B=active (a transmission power of Pb), C=inactive, and the like) and sets the communication interfaces B and C accordingly.

### 1.3) Effects

As described above, according to the first exemplary embodiment of the present invention, physical layer modes are defined between the control apparatus and each node, and in accordance with a physical layer mode designation about a specific port from the control apparatus, a communication setting of a physical device or physical devices associated with this port of a node is made. Thus, the control apparatus does not need to take into consideration the vendor-specific characteristics of physical devices provided to each node, and the load of controlling physical layer devices required for flow control is reduced.

Moreover, since the control apparatus can designate a physical layer mode of each port depending on the network status, each node can make communication setting of a physical layer device in itself in accordance with the designated mode, and the more efficient operation of the network is possible.

### 2. Second Exemplary Embodiment

According to a second exemplary embodiment of the present invention, one or more physical layer modes are defined for each port of each node as in the above-described first exemplary embodiment, and further a control apparatus determines a physical layer mode to notify to a node in accordance with a control policy. The control policy is updated depending on the network status. For example, a control policy can be generated or updated based on statistical information acquired from each node in a network. The generation or update of a control policy may be performed by management means provided within the control apparatus, or may be performed by management means provided on a network separately from the control apparatus.

Hereinafter, a description will be given of a case as an example where a communication interface at each node is a wireless communication apparatus, a control apparatus is a packet forwarding control apparatus, and each node is a packet forwarding function section, and where control policies are managed by a management apparatus that is different from the packet forwarding control apparatus.

### 2.1) System Architecture and Operation

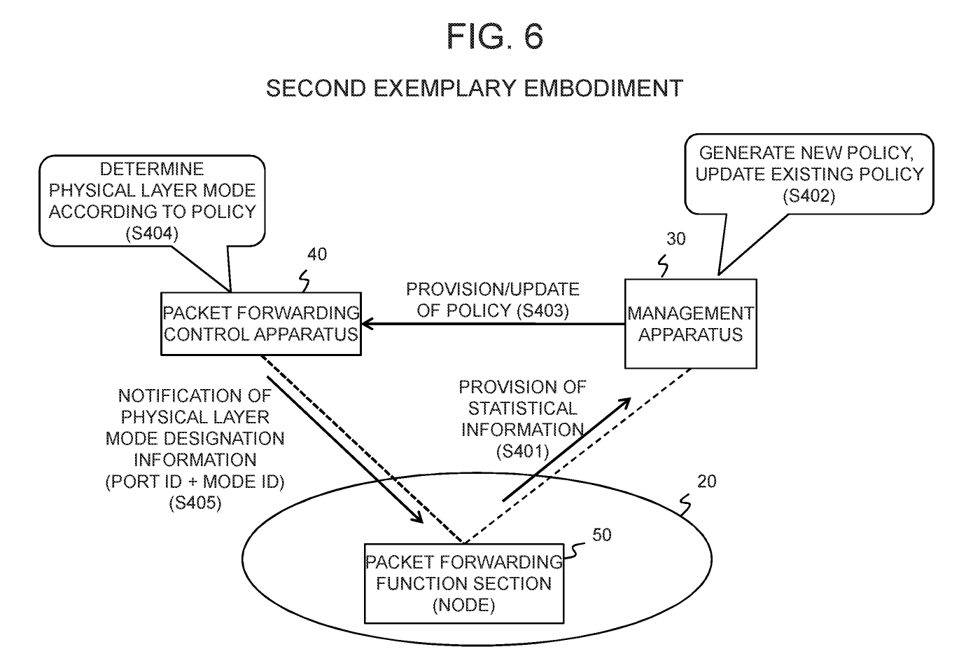

Referring to FIG. 6, it is assumed that a network system according to the second exemplary embodiment of the present invention includes a management apparatus 30, a packet forwarding control apparatus 40, and a plurality of packet forwarding function sections 50. For the management apparatus 30, for example, an EMS (Element Management System) or the like that directly manages network devices can be used. The management apparatus 30 and packet forwarding control apparatus 40 may constitute a single management system.

As in the first exemplary embodiment, the plurality of packet forwarding function sections 50 are connected through wired or wireless physical links, thereby constituting a network 20, and the packet forwarding control apparatus 40 performs flow control and physical layer mode control. The packet forwarding control apparatus 40 has functions similar to those of the control apparatus 10 in the first exemplary embodiment, and similarly the packet forwarding function sections 50 have functions similar to those of the nodes N, with the difference that the packet forwarding control apparatus 40 selects physical layer mode designation information in accordance with a control policy provided by the management apparatus 30. Details of the packet forwarding control apparatus 40 and packet forwarding function sections 50 will be described later.

Referring again to FIG. 6, the management apparatus 30 acquires statistical information relating to each flow at each packet forwarding function section 50 in the network 20 (Operation S401) and performs, for example, generation of a new control policy, update of an existing control policy, or the like depending on the network status obtained from the statistical information (Operation S402). For control policies, for example, a time-dependent policy for setting a low delay mode during daytime and setting a power saving mode during night time, a traffic-dependent policy for setting a low delay mode when traffic on the network 20 is larger than a predetermined value and setting a power saving mode when the traffic is not larger than the predetermined value, and the like can be employed. The management apparatus 30 notifies a new control policy or updated control policy set like this to the packet forwarding control apparatus 40 (Operation S403).

The packet forwarding control apparatus 40 determines a physical layer mode as described in the first exemplary embodiment, based on the control policy provided from the management apparatus 30 (Operation S404) and notifies a packet forwarding function section 50 of physical layer mode designation information including, for example, a combination of a port ID and a mode ID (Operation S405). For example, if a control policy for setting a low delay mode during daytime (e.g., from 9:00 a.m. to 5:00 p.m.) and setting a power saving mode during night time (e.g., from 9:00 p.m. to 6:00 a.m.) is designated, the packet forwarding control apparatus 40 selects and notifies to each packet forwarding function section 50 a physical layer mode in which the network 20 operates with low delays when it is daytime, and selects and notifies to each packet forwarding function section 50 a physical layer mode in which the network 20 operates in a power saving mode when it becomes night time. The management apparatus 30 can notify a control policy with updated daytime/night-time hours to the packet forwarding control apparatus 40, or can change to another control policy (e.g., the above-mentioned traffic-dependent control policy).

### <Packet Forwarding Control Apparatus>

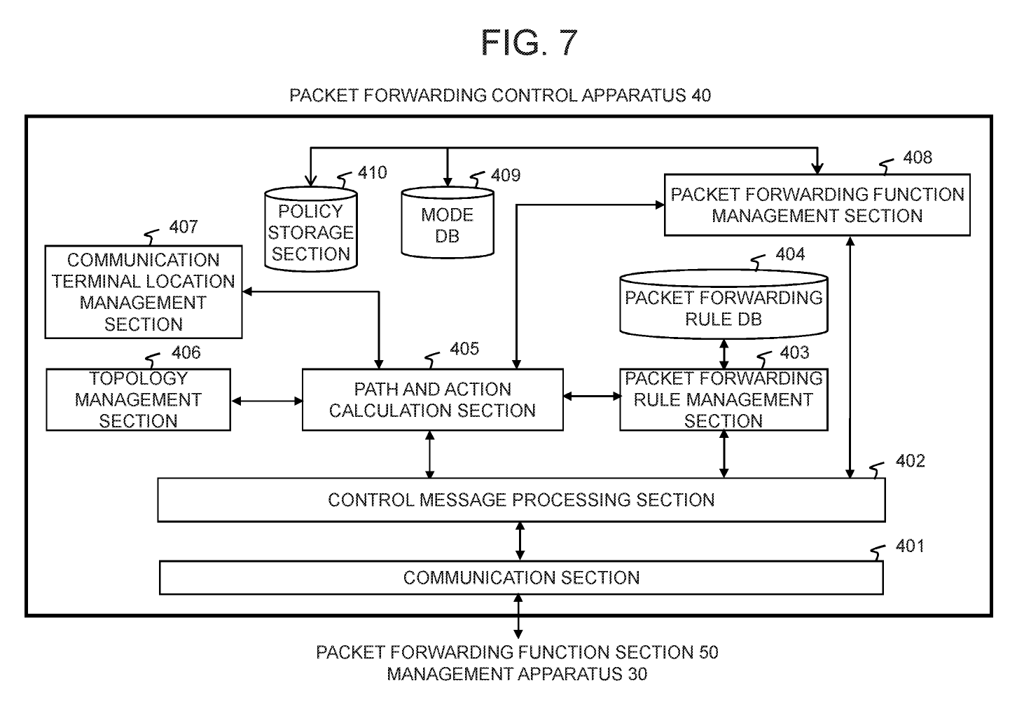

Referring to FIG. 7, the packet forwarding control apparatus 40 according to the present exemplary embodiment includes a communication section 401 for connecting to the network and communicating with the packet forwarding function sections 50 and management apparatus 30, and further includes functional sections (a control message processing section 402, a packet forwarding rule management section 403, a packet forwarding rule DB 404, a path and action calculation section 405, a topology management section 406, a communication terminal location management section 407, and a packet forwarding function management section 408) for performing routing in units of flows.

The packet forwarding control apparatus 40 according to the present exemplary embodiment still further includes a mode DB 409 and a policy storage section 410, which are managed by the packet forwarding function management section 408. In management of the capabilities of the packet forwarding function sections 50, the packet forwarding function management section 408 stores and manages the ports of the packet forwarding function sections 50 and the physical layer modes associated with the ports in the mode DB 409. The mode DB 409 stores a table in which one or more physical layer modes are defined for each port of each packet forwarding function section 50, which will be described later.

Moreover, the packet forwarding function management section 408 stores a control policy received from the management apparatus 30 via the communication section 401 and control message processing section 402 in the policy storage section 410, and performs management according to the control policy. That is, the packet forwarding function management section 408 has a function of selecting an appropriate physical layer mode in accordance with the control policy by referring to the mode DB 409 and policy storage section 410.

### <Packet Forwarding Function Section>

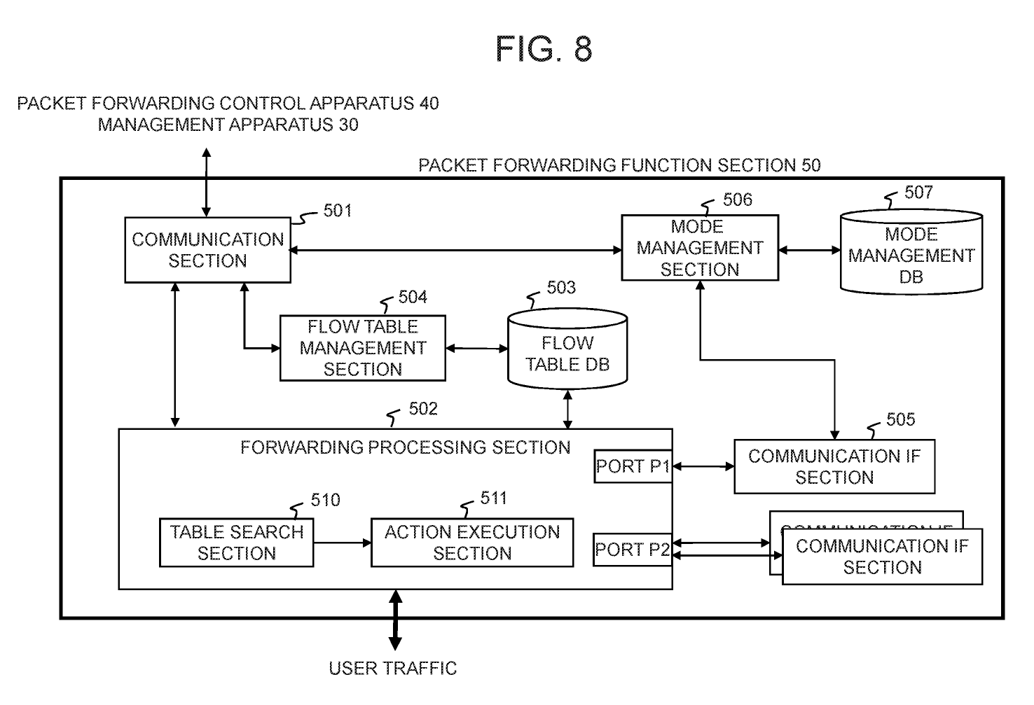

Referring to FIG. 8, the packet forwarding function section 50 according to the present exemplary embodiment includes a communication section 501 for communicating with the packet forwarding control apparatus 40 and management apparatus 30, and further includes functional sections (a forwarding processing section 502, a flow table DB 503, and a flow table management section 504) for performing packet forwarding under control in units of flows.

The forwarding processing section 502 includes two functional sections, namely, a table search section 510 and an action execution section 511, and a plurality of ports. One or a plurality of communication interface sections 505 are connected to each port of the forwarding processing section 502. The communication interference sections 505 are physical interfaces for electricity, radio waves, light, and the like and can include, for example, an Ethernet^{TM} (hereinafter, the same applies) interface and the like. The table search section 510 of the forwarding processing section 502 searches the flow table DB 503 by using Layer-1 to Layer-4 header information of a received packet, and if there is a matching flow entry, the action execution section 511 applies an action defined in this flow entry to the relevant received packet.

The mode management section 506 refers to the mode management DB 507 based on physical mode designation information (a port ID and a mode ID) indicated from the packet forwarding control apparatus 40 and can change the setting of communication interface section(s) 505. The mode management DB 507 stores communication interface setting information for each mode defined for each port.

Hereinafter, illustrating a wireless communication apparatus as a communication interface section 505, a first example in which one communication interface is associated with a port and a second example in which a plurality of communication interfaces are associated with a port will be described in detail with reference to drawings.

### 2.2) First Example

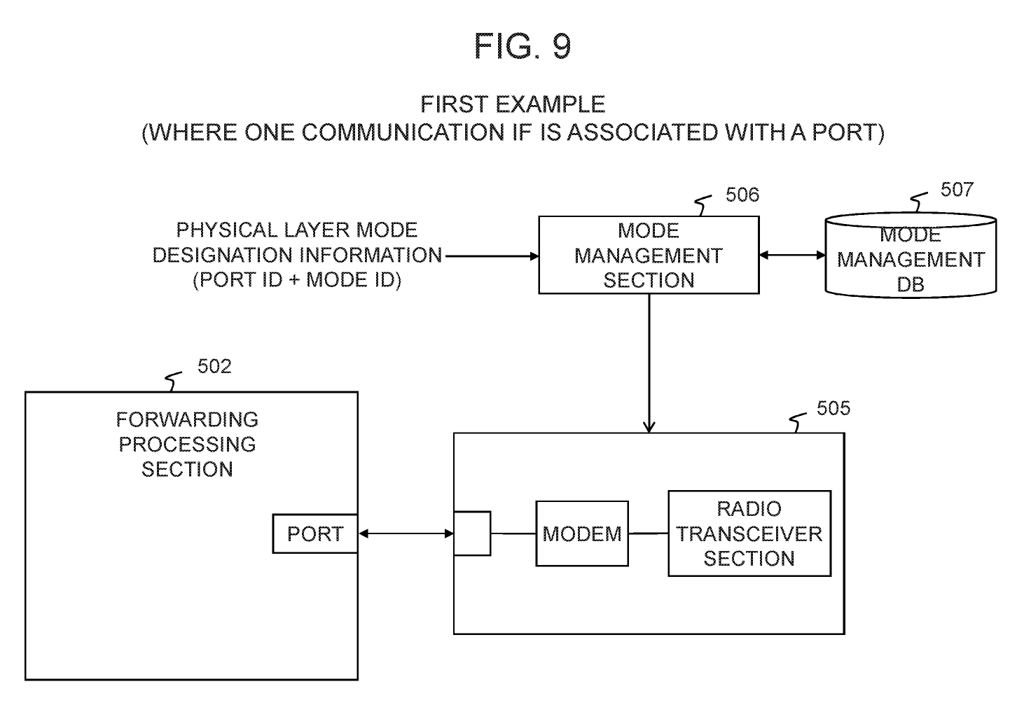

FIG. 9 illustrates a configuration around a port of the forwarding processing section 502 in the packet forwarding function section 50 shown in FIG. 8. In the first example, it is assumed that a single wireless communication interface section 505 is connected to the port of the forwarding processing section 502, and that the transmission power of a radio transceiver section in the wireless communication interface section 505 can be controlled by the mode management section 506. Hereinafter, a description will be given of an example of the data structures of the mode DB 409 of the packer forwarding control apparatus 40 and the mode management DB 507 of the packet forwarding function section 50 in the first example.

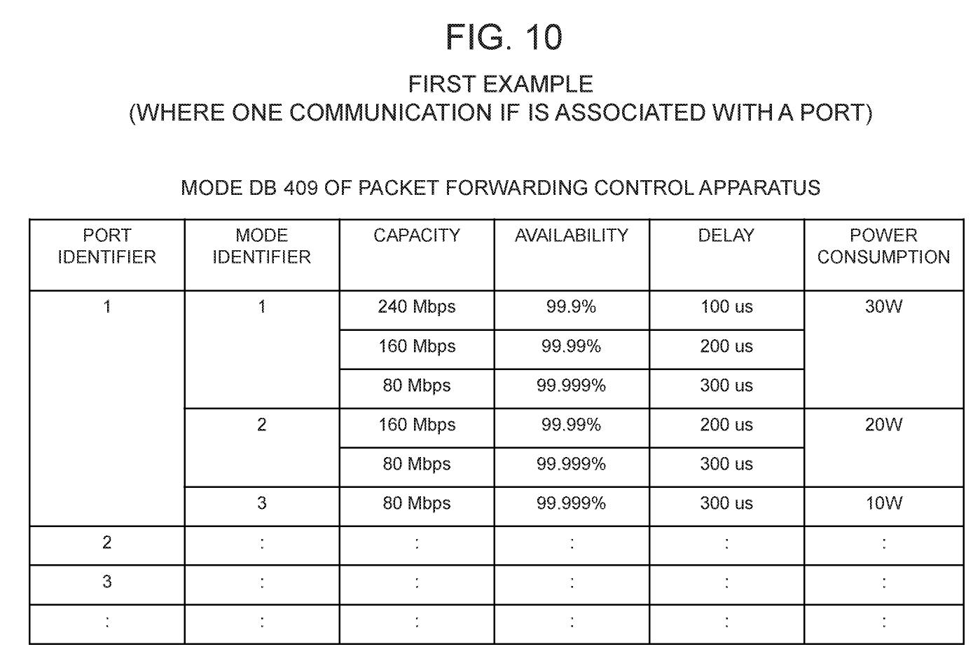

Referring to FIG. 10, the mode DB 409 of the packet forwarding control apparatus 40 stores mode information for each port of each node. Three modes (mode ID=1, 2, 3) are defined for port ID=1 of a node shown in FIG. 10. Here, each physical layer mode is defined by power consumption. For example, a power consumption of 30 W corresponds to a combination of port ID=1 and mode ID=1, a power consumption of 20 W corresponds to a combination of port ID=1 and mode ID=2, and a power consumption of 10 W corresponds to a combination of port ID=1 and mode ID=3. Accordingly, information specifying a physical layer mode (here, a combination of a port ID and a mode ID) can be used to designate a physical layer condition (power consumption) of this port. Note that when the mode is changed, the transmission power of the communication interface section 505 is changed, and accordingly the modulation scheme applicable in adaptive modulation is also changed, which reflects on the upper limit of a capacity in each mode.

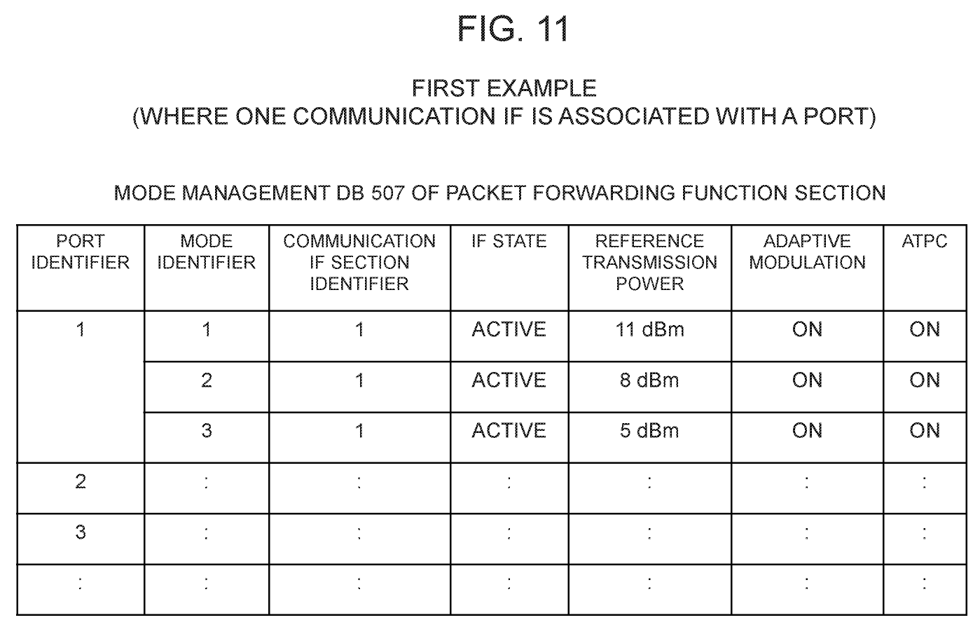

Referring to FIG. 11, the mode management DB 507 of the packet forwarding function section 50 stores communication interface setting information for each mode defined for each port. Combinations of a port and a mode in the mode management DB 507 correspond to the combinations of a port and a mode defined in the mode DB 409 of the packet forwarding control apparatus 40. Moreover, since a communication interface ID is provided correspondingly to a mode ID, the mode management section 506 can solve a correspondence between a port and a communication interface section 505 by referring to the mode management DB 507.

Port ID=1 shown in FIG. 11 corresponds to the port shown in FIG. 9, and three modes (mode ID=1, 2, 3) are defined for this port. These modes correspond to three setting states of the wireless communication interface section 505, respectively. Here, the mode management section 506 can change the reference transmission power of the wireless communication interface section 505 in accordance with physical layer mode designation information (a port ID and a mode ID) selected by the packet forwarding control apparatus 40 in accordance with a control policy.

Note that although wireless transport is assumed in the first example, the present exemplary embodiment is not limited to wireless transport. Moreover, in the first example, since one wireless communication interface section 505 is connected to a port, the interface state of the wireless communication interface section 505 is fixed to “ACTIVE”, adaptive modulation is fixed to “ON”, and automatic transmission power control (ATPC) is fixed to “ON”. Moreover, the mode management DB 507 does not include the information of the mode DB 409 of the packet forwarding control apparatus 40 in the first example, but may include it.

### 2.3) Second Example

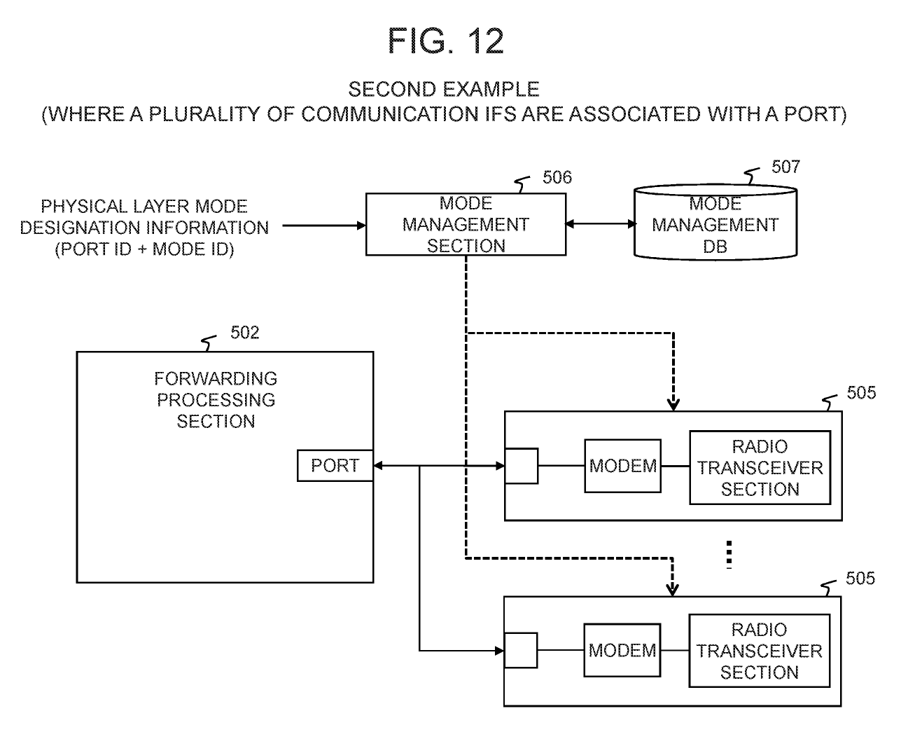

FIG. 12 illustrates a configuration around a port of the forwarding processing section 502 in the packet forwarding function section 50 shown in FIG. 8. In the second example, it is assumed that a plurality of wireless communication interface sections 505 are connected to the port of the forwarding processing section 502, and that the transmission power of radio transceiver sections in the wireless communication interface sections 505 are constant and the IF states (active/inactive) thereof can be controlled by the mode management section 506. Accordingly, the number of active wireless communication interface sections 505 can be changed through control by the mode management section 506, and consequently the capacity of data to be transmitted/received by the port can be changed. Hereinafter, to simplify the description, illustrating a case where three wireless communication interface sections 505 are connected to the port, a description will be given of an example of the data structures of the mode DB 409 of the packet forwarding control apparatus 40 and the mode management DB 507 of the packet forwarding function section 50 in the second example.

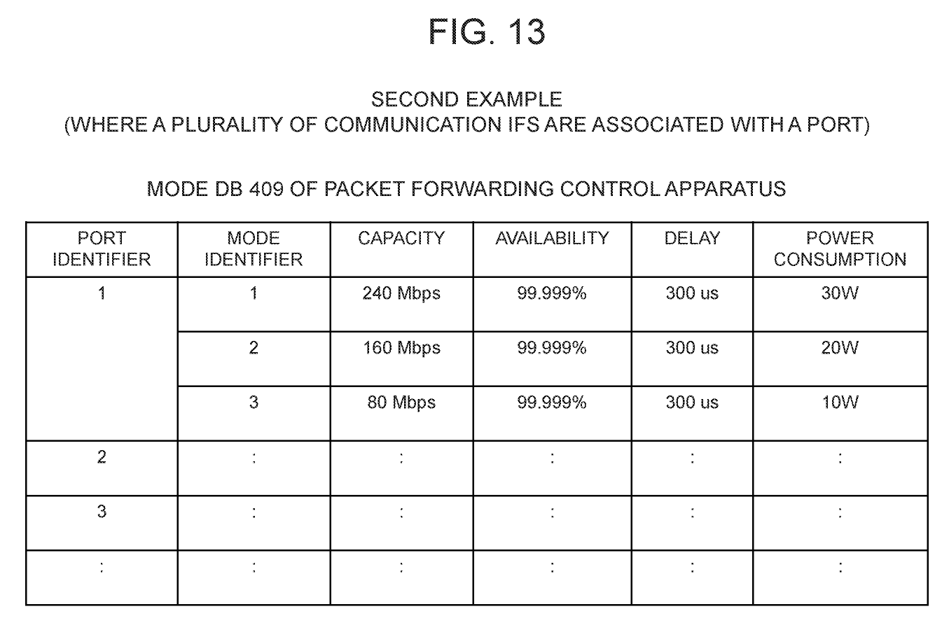

Referring to FIG. 13, the mode DB 409 of the packet forwarding control apparatus 40 stores mode information for each port of each node. Three modes (mode ID=1, 2, 3) are defined for port ID=1 of a node shown in FIG. 13. Here, each physical layer mode is defined by power consumption/capacity. For example, a power consumption of 30 W/a capacity of 240 Mbps corresponds to a combination of port ID=1 and mode ID=1, a power consumption of 20 W/a capacity of 160 Mbps corresponds to a combination of port ID=1 and mode ID=2, and a power consumption of 10 W/a capacity of 80 Mbps corresponds to a combination of port ID=1 and mode ID=3. Accordingly, information specifying a physical layer mode (here, a combination of a port ID and a mode ID) can be used to designate a physical layer condition (power consumption/capacity) of this port. Note that as described above, when the mode is changed, the number of active communication interfaces at the port is changed, which reflects on the capacity varying with mode.

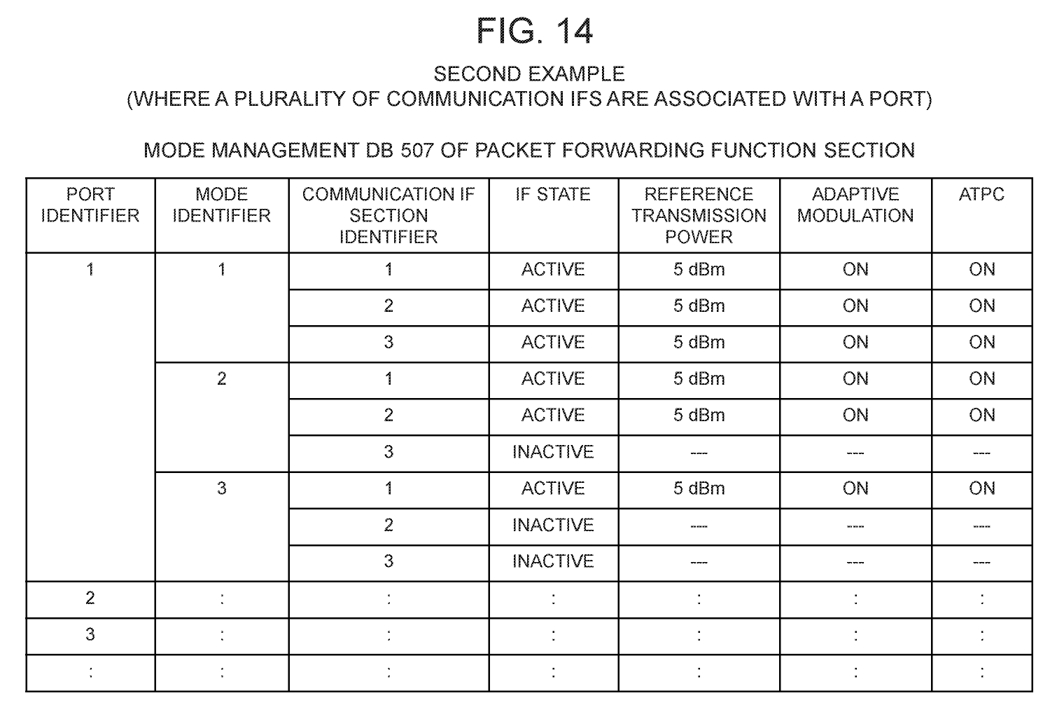

Referring to FIG. 14, the mode management DB 507 of the packet forwarding function section 50 stores communication interface setting information for each mode defined for each port. Combinations of a port and a mode in the mode management DB 507 correspond to the combinations of a port and a mode defined in the mode DB 409 of the packet forwarding control apparatus 40. Moreover, since a communication interface ID and a flag of its state (active/inactive) are provided correspondingly to a mode ID, the mode management section 506 can solve a correspondence between a port and active communication interface sections 505 by referring to the mode management DB 507.

Port ID=1 shown in FIG. 14 corresponds to the port shown in FIG. 12, and three modes (mode ID=1, 2, 3) are defined for this port. These modes have different numbers of active wireless communication interface sections 505. Here, the mode management section 506 makes the wireless communication interface sections 505 active in different numbers in accordance with physical layer mode designation information (a port ID and a mode ID) selected by the packet forwarding control apparatus 40 in accordance with a control policy. For example, all three wireless communication interface sections 505 are made active for the combination of port ID=1 and mode ID=1, two wireless communication interface sections 505 are made active for the combination of port ID=1 and mode ID=2, and one wireless communication interface section 505 is made active for the combination of port ID=1 and mode ID=3.

As described above, the packet forwarding control apparatus 40 designates a desired physical layer condition (here, power consumption/capacity) by using physical layer mode designation information (a combination of a port ID and a mode ID) according to a control policy, whereby the packet forwarding function section 50 can make setting of physical devices (here, the wireless communication interface sections) in itself based on the designated physical layer condition.

Note that although wireless transport is assumed in the second example, the present exemplary embodiment is not limited to wireless transport. Moreover, in the second example, a case is illustrated where three wireless communication interface sections 505 are connected to a port, but in general, the present exemplary embodiment is applicable in cases where a plurality of communication interfaces are provided.

### 2.4) Effects

As described above, according to the second exemplary embodiment of the present invention, in addition to effects similar to those of the first exemplary embodiment, the control apparatus determines a physical layer mode to notify to a node in accordance with a control policy. A control policy is generated or updated based on the network status (e.g., statistical information acquired from each node in the network). Since the control apparatus can designate a physical layer mode of each port depending on the network status, each node makes a communication setting of physical layer device(s) in itself in accordance with the designated physical layer mode, whereby the more efficient operation of the network is possible.

### 3. Third Exemplary Embodiment

According to a third exemplary embodiment of the present invention, one or more physical layer modes are defined for each port of each node as in the above-described first exemplary embodiment, and further a control apparatus also manages the transmission direction of a link between nodes. Moreover, the control apparatus determines a physical layer mode to notify to a node in accordance with a control policy as in the second exemplary embodiment, whereby a physical layer mode of each port can be designated for each direction of a link between nodes depending on the network status, and the more efficient operation of the network is possible.

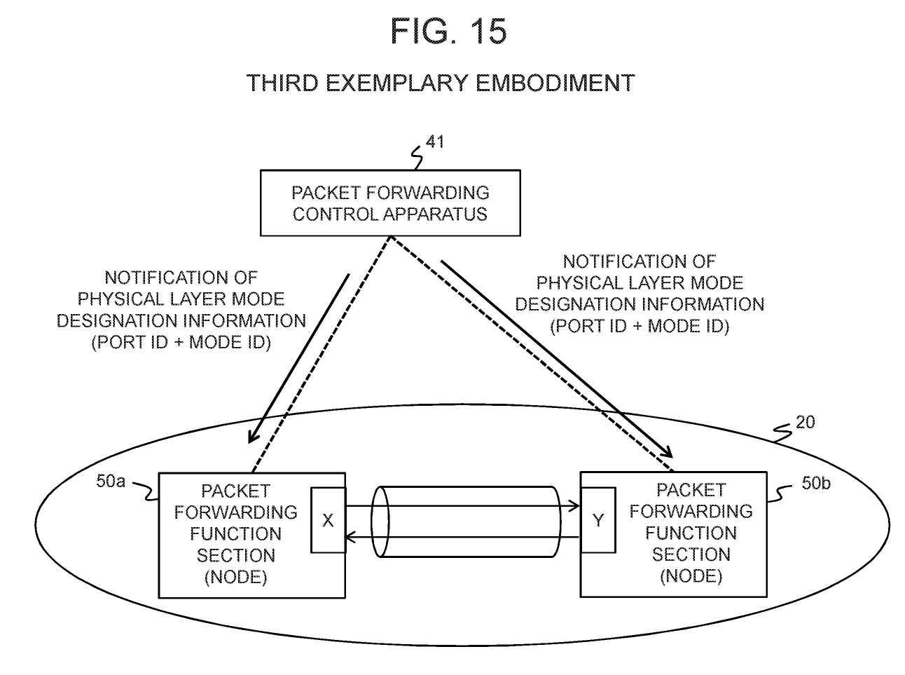

Referring to FIG. 15, a network system according to the third exemplary embodiment of the present invention includes a packet forwarding control apparatus 41 and a plurality of packet forwarding function sections 50. The plurality of packet forwarding function sections 50 are connected through wired or wireless physical links, thereby constituting a network 20, and the packet forwarding control apparatus 41 performs flow control and physical layer mode control as in the second exemplary embodiment. The packet forwarding control apparatus 41 performs physical layer mode control similar to those of the first and second exemplary embodiments, based on the data transmission direction of a link between any adjacent packet forwarding function sections 50a and 50b. Hereinafter, the present exemplary embodiment will be described, assuming that a link is configured between a port X of the packet forwarding function section 50a and a port Y of the packet forwarding function section 50b.

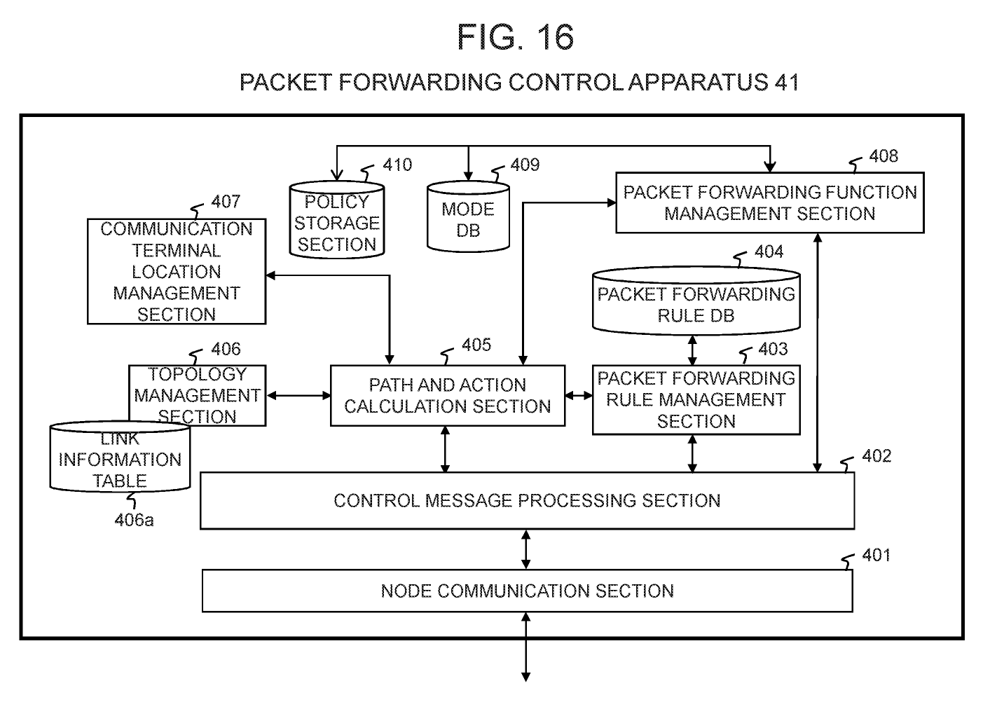

Referring to FIG. 16, the packet forwarding control apparatus 41 basically has the same configuration as the packet forwarding control apparatus 40 shown in FIG. 7, with the difference that a link information table 406a is provided to the topology management section 406. Accordingly, those blocks having the same functions as in FIG. 7 are given the same reference signs, and a description thereof will be omitted. Moreover, the packet forwarding function sections 50a and 50b have the same configuration as the packet forwarding function section 50 shown in FIG. 8, and therefore a description thereof will be omitted.

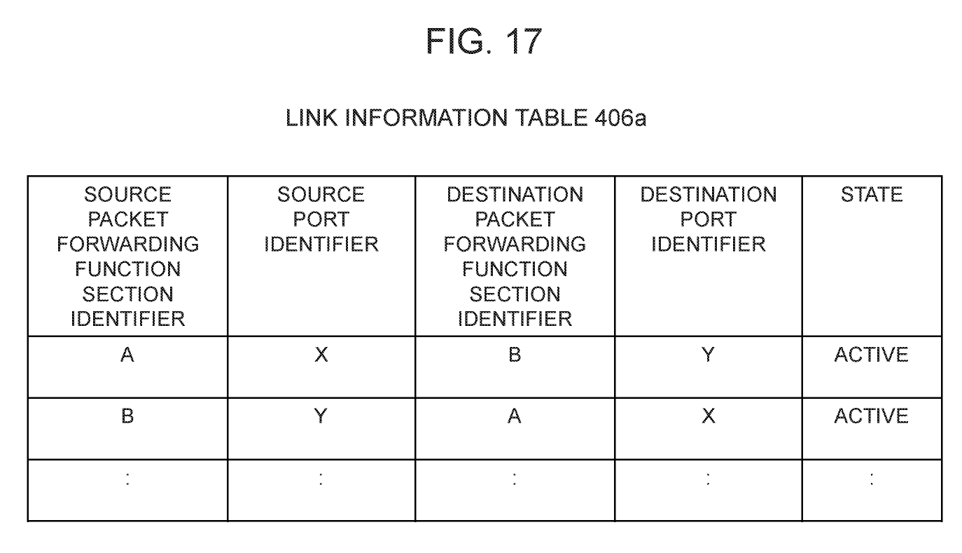

Referring to FIG. 17, in the link information table 406a, a source packet forwarding function section ID and a source port ID, a destination packet forwarding function section ID and a destination port ID, and the state (active/inactive) of a corresponding flow are registered with respect to each of a flow in one direction and a flow in the opposite direction. For example, with respect to a flow from the packet forwarding function section 50a to the packet forwarding function section 50b, the source packet forwarding function section ID is “A”, the source port ID, “X”, the destination packet forwarding function section ID, “B”, the destination port ID, “Y”, and the flow state, “ACTIVE”.

The packet forwarding function management section 408 of the packet forwarding control apparatus 41 can select an appropriate physical layer mode according to a control policy for a communication interface at the port X of the packer forwarding functional section 50a or at the port Y of the packet forwarding function section 50b by referring to the mode DB 409, policy storage section 410, and link information table 406a.

As described above, according to the third exemplary embodiment of the present invention, in addition to the effects of the above-described first and second exemplary embodiments, appropriate physical layer modes can be designated depending on the network status for each direction of a link between adjacent nodes, for a source port and a destination port at these nodes, and the more efficient operation of the network is possible.

### 4. Fourth Exemplary Embodiment

According to a fourth exemplary embodiment of the present invention, a plurality of physical layer modes are defined for each port of each node as in the above-described first exemplary embodiment, and further a control apparatus can perform communication control or path selection taking into consideration the reliability of communication between nodes, by using a redundant configuration at each port. Moreover, the control apparatus determines a physical layer mode to notify to a node in accordance with a control policy as in the second exemplary embodiment, whereby it is also possible to switch paths between nodes depending on the network status.

### 4.1) System Architecture

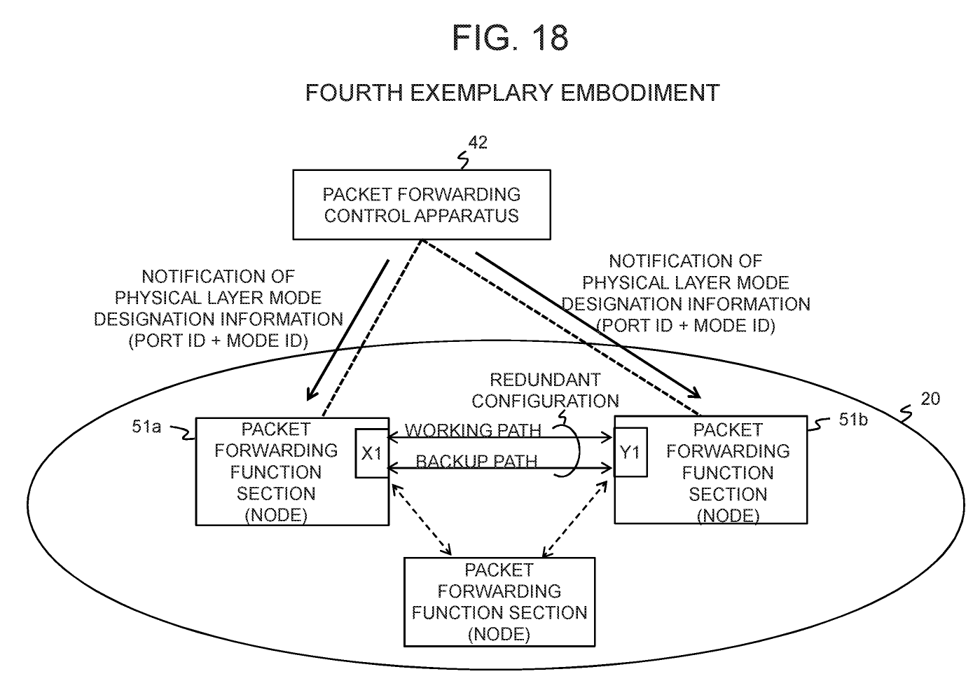

Referring to FIG. 18, a network system according to the fourth exemplary embodiment of the present invention includes a packet forwarding control apparatus 42 and a plurality of packet forwarding function sections 51. The plurality of packet forwarding function sections 51 are connected through wired or wireless physical links, thereby constituting a network 20, and the packet forwarding control apparatus 42 performs flow control and physical layer mode control as in the second exemplary embodiment. The packet forwarding control apparatus 42 configures redundant paths between any packet forwarding function sections 51a and 51b, one of which is used for a working path, and the other of which is used for a backup path. Hereinafter, the present exemplary embodiment will be described, taking a case as an example where a working path and a backup path are configured between a port X1 of the packet forwarding function section 51a and a port Y1 of the packet forwarding function section 51b.

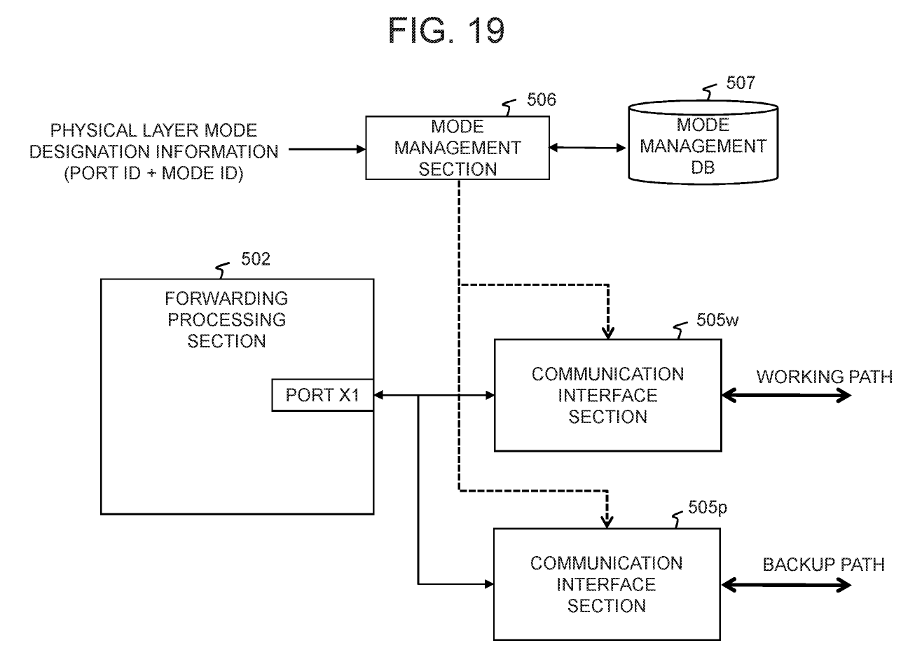

FIG. 19 illustrates a configuration around the port of the forwarding processing section 502 of the packet forwarding function section 51a shown in FIG. 18. Two wireless communication interface sections 505w and 505p are connected to the port X1 of the forwarding processing section 502. The wireless communication interface sections 505w and 505p may have the same physical parameters, or may have different, for example, frequency bands or wavelength bands for use. Here, it is assumed that the wireless communication interface section 505w is set for the working path while the wireless communication interface section 505p is set for the backup path. That is, the mode management section 506 sets the wireless communication interface section 505w to be normally active and sets the wireless communication interface section 505p to be normally standby, in accordance with physical layer mode designation information from the packet forwarding control apparatus 42.

For example, when a failure occurs in the path itself for the wireless communication interface section 505w in a normal state, the other wireless communication interface section 505p is made active, whereby communication can be maintained. Moreover, if a backup path is configured separately from a working path, communication can be maintained by switching to the backup path even when a failure occurs in the working path.

### 4.2) Operation

### First Example

Hereinafter, a description will be given of an example of the data structures of the mode DB 409 of the packet forwarding control apparatus 42 and the mode management DB 507 of the packet forwarding function section 51, taking a case as an example where two paths with the same communication parameters are configured between the port X1 of the packet forwarding function section 51a and the port Y1 of the packet forwarding function section 51b.

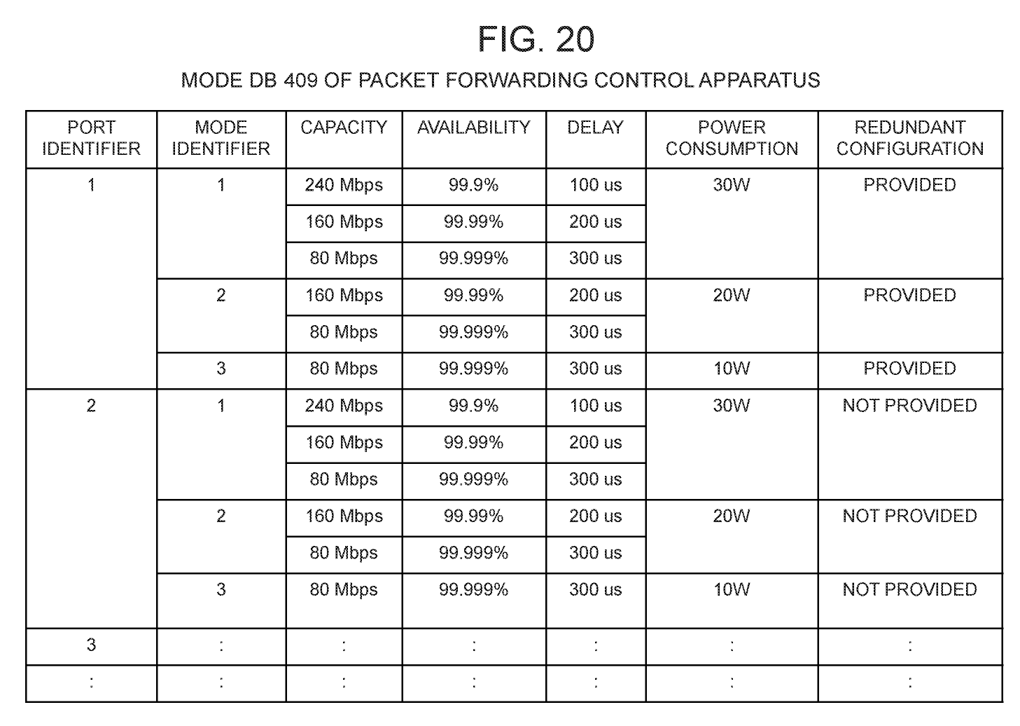

Referring to FIG. 20, the mode DB 409 of the packet forwarding control apparatus 42 stores mode information for each port of each node. For a node shown in FIG. 12, three modes (mode ID=1, 2, 3) are defined for port ID=1, and each physical layer mode is defined by power consumption and whether a redundant configuration is provided/not provided. For example, for port ID=1, mode ID=1 corresponds to a power consumption of “30 W” and a redundant configuration “PROVIDED”, mode ID=2 corresponds to a power consumption of “20 W” and a redundant configuration “PROVIDED”, and mode ID=3 corresponds to a power consumption of “10 W” and a redundant configuration “PROVIDED”, while for port ID=2, the same communication parameters are set, with a redundant configuration “NOT PROVIDED”. Accordingly, information specifying a physical layer mode (here, a combination of a port ID and a mode ID) can be used to designate a physical layer condition (power consumption) of this port, taking into consideration the reliability of communication (whether a redundant configuration is provided/not provided). Note that when the mode is changed, the transmission power of a communication interface section 505 is changed, and accordingly the modulation scheme applicable in adaptive modulation is also changed, which reflects on the upper limit of a capacity in each mode.

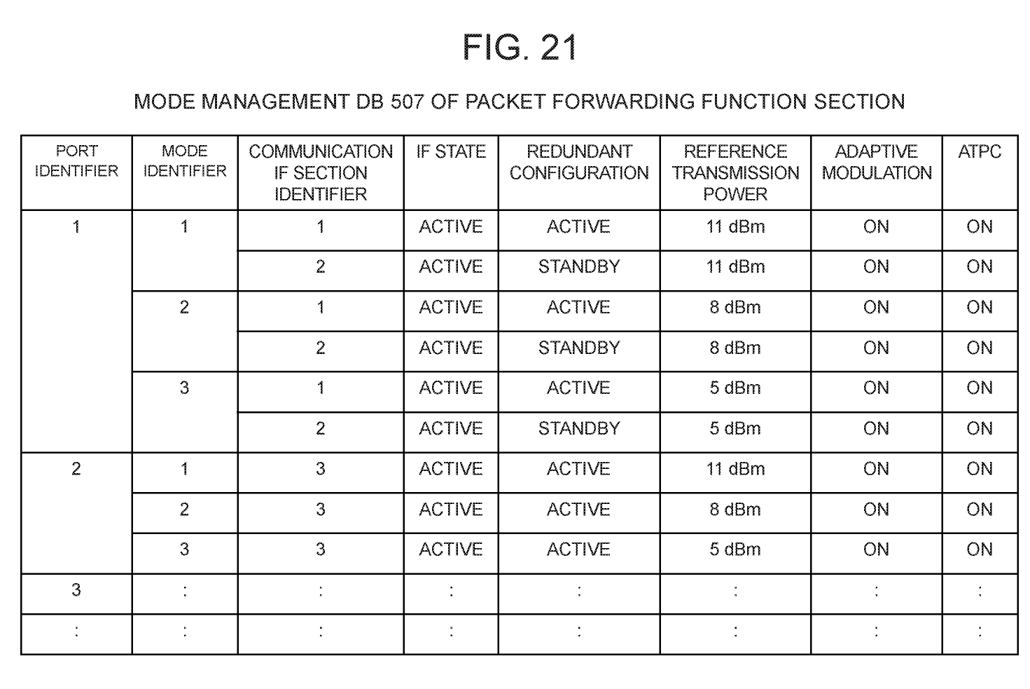

Referring to FIG. 21, the mode management DB 507 of the packet forwarding function section 51 stores communication interface setting information for each mode defined for each port. Combinations of a port and a mode in the mode management DB 507 correspond to the combinations of a port and a mode defined in the mode DB 409 of the packet forwarding control apparatus 42. Since port ID=1 has a redundant configuration, two communication interface IDs and flags of their respective states (active/inactive) are provided for one mode ID. When the redundant configuration is functioning, the communication interface state is “ACTIVE” for both, and the redundant configuration is “ACTIVE” for one and is “STANDBY” for the other. Since port ID=2 has no redundant configuration, the state of a single communication interface section 505 is “ACTIVE” and the redundant configuration is “ACTIVE”. The mode management section 506 can solve a correspondence between a port and an active communication interface section 505 by referring to the mode management DB 507.

### Second Example

In a case where the packet forwarding control apparatus 42 designates a desired physical layer condition by using physical layer mode designation information (a combination of a port ID and a mode ID) according to a control policy as described in the second exemplary embodiment, selection of a redundant configuration can be controlled depending on the network status. For example, a port having a redundant configuration (port ID=1) is selected when higher reliability is required, and otherwise a port having no redundant configuration (port ID=2) is selected. Alternatively, ports are switched depending on the network status, whereby it is also possible to change paths.

### 4.3) Effects

According to the fourth exemplary embodiment of the present invention, in addition to the effects of the above-described first to third exemplary embodiments, the control apparatus can perform communication control or path selection taking into consideration the reliability of communication between nodes, by using a redundant configuration at each port. Moreover, a physical layer mode to notify to a node is determined in accordance with a control policy, whereby it is possible to perform communication control or path switching between nodes using a redundant configuration, depending on the network status.

### 5. Fifth Exemplary Embodiment

According to a fifth exemplary embodiment of the present invention, one or more physical layer modes are defined for each port of each node as in the above-described first exemplary embodiment, and further a control apparatus changes link directions between nodes and physical layer conditions on a time-division basis. The control apparatus can determine a physical layer mode to notify to a node in accordance with a control policy as in the second exemplary embodiment, and further depending on a temporal control segment. More specifically, the link direction between nodes and the physical layer condition thereof are changed according to time segments divided on a time-of-day basis, daily basis, monthly basis, seasonal basis, or the like, whereby it is possible to more efficiently operate the network according to changes with time in the amount and direction of traffic.

### 5.1) System Architecture

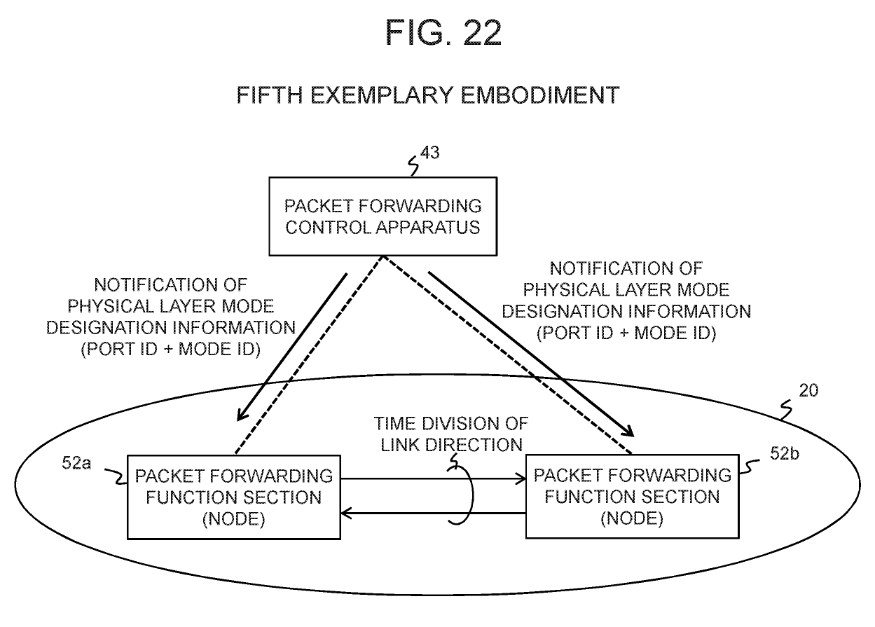

Referring to FIG. 22, a network system according to the fifth exemplary embodiment of the present invention includes a packet forwarding control apparatus 43 and a plurality of packet forwarding function sections 52. The plurality of packet forwarding function sections 52 are connected through wired or wireless physical links, thereby constituting a network 20, and the packet forwarding control apparatus 43 performs flow control and physical layer mode control as in the second exemplary embodiment. The packet forwarding control apparatus 43 manages a link in one direction and a link in the opposite direction (In-direction link and Out-direction link viewed from one node) between any packet forwarding function sections 52a and 52b, and can change physical layer modes on a time-division basis. It is assumed that a communication interface section 505 similar to that shown in FIG. 19 is provided to a port of each packet forwarding function section 52, and the mode management section 506 changes the setting of the communication interface section 505 in accordance with physical layer mode designation information.

Hereinafter, assuming that the packet forwarding control apparatus 43 has the configuration shown in FIG. 7 and each packet forwarding function section 52 has the configuration shown in FIG. 8, a description will be given of an example of the data structures of the mode DB 409 of the packet forwarding control apparatus 43 and the mode management DB 507 of the packet forwarding function section 52a. Here, it is assumed that the amount and direction of traffic in the packet forwarding function section 52a change with time of day.

### 5.2) Operation

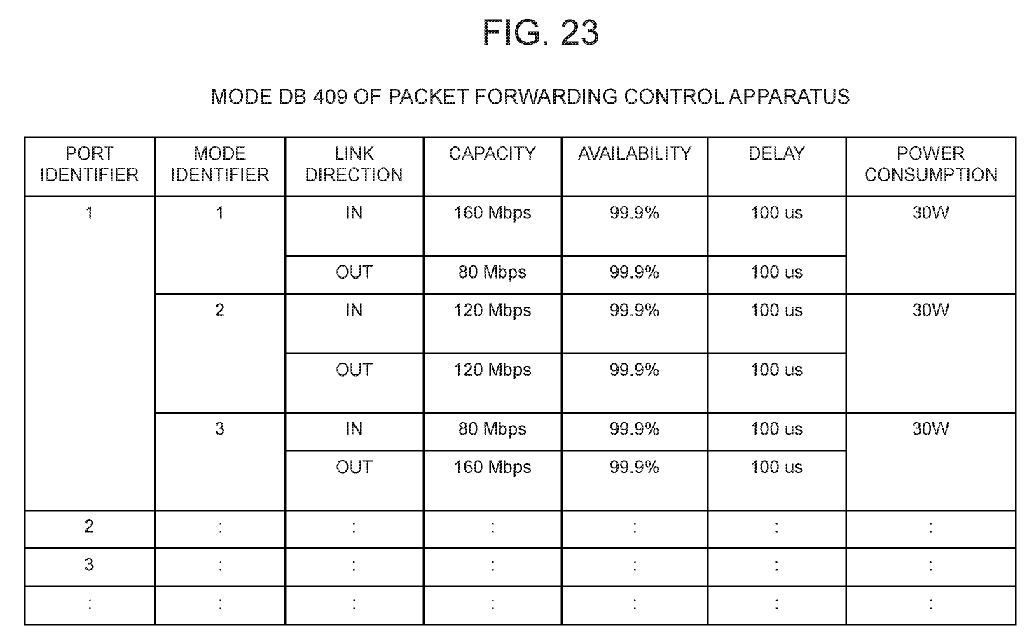

Referring to FIG. 23, the mode DB 409 of the packet forwarding control apparatus 43 stores mode information for each port of each node. For a node shown in FIG. 22, three modes (mode ID=1, 2, 3) are defined for port ID=1, and each physical layer mode is defined for the In-direction link and for the Out-direction link discretely. For example, for port ID=1, the capacity for mode ID=1 is “160 Mbps” in In direction and is “80 Mbps” in Out direction, the capacity for mode ID=2 is “120 Mbps” in In direction and is “120 Mbps” in Out direction, and the capacity for mode ID=3 is “80 Mbps” in In direction and “160 Mbps” in Out direction. Note that all of the modes have the same values under availability, delay, and power consumption. Accordingly, information specifying a physical layer mode (here, a combination of a port ID and a mode ID) can be used to designate a physical layer condition (capacity) in In direction or Out direction to be satisfied by this port.

For example, if it is statistically known that traffic in In direction is larger in the morning (6:00-12:00), traffic is approximately the same in In direction and in Out direction in the afternoon (12:00-18:00), and traffic in Out direction is larger during the night (18:00-6:00), then it is only necessary to set in the packet forwarding control apparatus 43 control policies that designate port ID=1 and mode ID=1 in the morning, port ID=1 and mode ID=2 in the afternoon, and port ID=1 and mode ID=3 during the night, respectively.

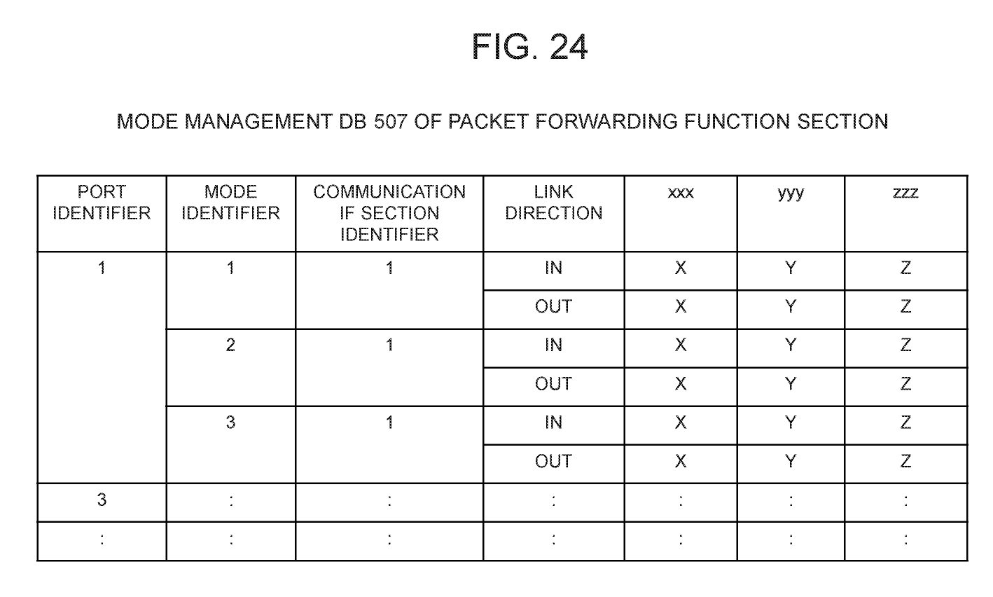

Referring to FIG. 24, the mode management DB 507 of the packet forwarding function section 52 stores communication interface setting information for each mode defined for each port. Combinations of a port and a mode in the mode management DB 507 correspond to the combinations of a port and a mode defined in the mode DB 409 of the packet forwarding control apparatus 43. As described above, if port ID=1 and mode ID=1, for example, the reference transmission power in In direction at the wireless communication interface section 505 is increased, and if port ID=1 and mode ID=3, for example, the reference transmission power in Out direction at the wireless communication interface section 505 is increased.

### 5.3) Effects

According to the fifth exemplary embodiment of the present invention, in addition to the effects of the above-described first to fourth exemplary embodiments, the link direction between nodes and the physical layer condition thereof are changed on a time-division basis, whereby it is possible to more efficiently operate the network according to changes with time in the amount and direction of traffic.

### INDUSTRIAL APPLICABILITY

The present invention can be applied to systems for SDN-based transport networks.

### REFERENCE SIGNS LIST

10 Control apparatus
20 Network
30 Management apparatus
40-43 Packet forwarding control apparatus
50-52 Packet forwarding function section
101 Node communication section
102 Packet forwarding rule database
103 Mode database
104 Control section
201 Communication section
202 Flow table
203 Packet forwarding processing section
204 Mode management section
205 Mode management database
404 Packet forwarding rule database
409 Mode database
410 Policy storage section
502 Forwarding processing section
503 Flow table
505 Communication interface section
506 Mode management section
507 Mode management database

1-6. (canceled)

7. A node apparatus in a network controlled by a control apparatus, comprising:
a plurality of ports to transmit or receive packets to or from the network;
at least one communication interface provided to each of the plurality of ports; and
a controller configured to:
make setting of a communication interface provided to a port designated by the control apparatus according to a physical layer mode of the port; and
forward packets in accordance with control for each flow by the control apparatus.

8. The node apparatus according to claim 7, wherein the controller includes a table in which, for each port, least one physical layer modes is associated with a physical parameter of a communication interface.

9. The node apparatus according to claim 7, wherein the physical layer mode corresponds to an operational condition to be satisfied by the communication interface, wherein the controller sets a physical parameter of the communication interface according to the operational condition.

10. The node apparatus according to claim 7, wherein the communication interface is configured to adjust at least transmission power.

11. The node apparatus according to claim 10, wherein the communication interface includes a plurality of transceiver sections, and adjusts the transmission power by changing a number of active ones of the plurality of transceiver sections.

12. The node apparatus according to claim 7, wherein the communication interface is configured to adjust at least power consumption.

13. A control apparatus that performs flow control for each of a plurality of nodes constituting a network, comprising:
a mode table in which at least one physical layer modes is defined for each port of the node; and
controller configured to notify a node of mode designation information for designating a physical layer mode of one port of the node.

14. The control apparatus according to claim 13, wherein the physical layer mode corresponds to an operational condition of a communication interface provided to the port of the node, wherein the node makes physical parameter setting on the communication interface according to the operational condition, in accordance with the mode designation information.

15. The control apparatus according to claim 13, wherein the controller selects the physical layer mode of the port to designate to the node, in accordance with a predetermined control policy.

16. The control apparatus according to claim 15, wherein the controller generates or updates the control policy based on statistical information provided from each node in the network.

17. The control apparatus according to claim 15, wherein the control policy is provided by a management apparatus managing the network.

18-23. (canceled)

24. A communication control method for a node apparatus, wherein the node apparatus includes: a plurality of ports to transmit or receive packets to or from a network controlled by a control apparatus; at least one communication interface provided to each of the plurality of ports; and the method comprising:
receiving mode designation information for designating a physical layer mode of a port from the control apparatus; and
making setting of a communication interface provided to a port designated by the control apparatus according to a physical layer mode of the port; and
forwarding packets in accordance with control for each flow by the control apparatus.

25. The communication control method according to claim 24, further comprising:
in accordance with the mode designation information, referring to a table in which at least one physical layer modes is associated with a physical parameter of a communication interface for each port, wherein the setting of the communication interface is made based on the physical parameter retrieved from the table.

26. The communication control method according to claim 24, wherein the physical layer mode corresponds to an operational condition to be satisfied by the communication interface, wherein a physical parameter of the communication interface is set based on the operational condition.

27. The communication control method according to claim 24, wherein the communication interface is configured to adjust at least transmission power.

28. The communication control method according to claim 27, wherein the communication interface includes a plurality of transceiver sections, and the transmission power is adjusted by changing a number of active ones of the plurality of transceiver sections.

29. The communication control method according to claim 24, wherein the communication interface is configured to adjust at least power consumption.

30-36. (canceled)

37. A communication system comprising:
a node apparatus according to claim 7; and
a control apparatus that performs flow control for each of a plurality of nodes constituting a network, comprising:
a mode table in which at least one physical layer modes is defined for each port of the node; and
a controller configured to notify a node of mode designation information for designating a physical layer mode of one port of the node.
